(19) United States
(12) Patent Application Publication
(10) Pub. No.: US 2025/0159607 A1
(43) Pub. Date: May 15, 2025

(54) WAKE-UP SIGNAL MONITORING METHOD AND APPARATUS, WAKE-UP SIGNAL MONITORING INDICATION METHOD AND APPARATUS, TERMINAL, AND NETWORK-SIDE DEVICE

(71) Applicant: VIVO MOBILE COMMUNICATION CO., LTD., Dongguan (CN)

(72) Inventors: Dongru LI, Dongguan (CN); Xin QU, Dongguan (CN); Li CHEN, Dongguan (CN)

(21) Appl. No.: 19/023,824

(22) Filed: Jan. 16, 2025

Related U.S. Application Data
(63) Continuation of application No. PCT/CN2023/105418, filed on Jun. 30, 2023.

(30) Foreign Application Priority Data
Jul. 20, 2022 (CN) 202210863395.2

(51) Int. Cl. H04W 52/02

(52) U.S. Cl. CPC H04W 52/0229

(57) ABSTRACT

This application discloses a wake-up signal monitoring method and apparatus, a wake-up signal monitoring indication method and apparatus, a terminal, and a network-side device, pertaining to the field of communications technologies. The wake-up signal monitoring method of embodiments of this application includes: determining, by a terminal, wake-up signal monitoring time information in H beacon signal monitoring periodicities based on first information, where H is an integer greater than or equal to 1; and monitoring, by the terminal, a wake-up signal based on the wake-up signal monitoring time information; where the first information includes at least one of the following parameters: beacon signal configuration information, wake-up signal configuration information of the terminal, time unit configuration information, wake-up signal monitoring configuration information, and monitoring relationship configuration information.

### CROSS-REFERENCE TO RELATED APPLICATIONS

This application is a continuation application of International Application No. PCT/CN2023/105418, filed on Jun. 30, 2023, which claims priority to Chinese Patent Application No. 202210863395.2, filed in China on Jul. 20, 2022, both of which are incorporated herein by reference in its entirety.

### TECHNICAL FIELD

This application pertains to the field of communications technologies, and specifically, relates to a wake-up signal monitoring method and apparatus, a wake-up signal monitoring indication method and apparatus, a terminal, and a network-side device.

### BACKGROUND

In mobile communication systems, how to reduce terminal power consumption is a crucial technical problem. In one solution, a terminal monitors a low power wake-up signal (low power wake up signal, LP-WUS) to determine whether there is a communication service transmission requirement at present.

### SUMMARY

Embodiments of this application provide a wake-up signal monitoring method and apparatus, a wake-up signal monitoring indication method and apparatus, a terminal, and a network-side device.

According to a first aspect, a wake-up signal monitoring method is provided, including:
determining, by a terminal, wake-up signal monitoring time information in H beacon signal monitoring periodicities based on first information, where H is an integer greater than or equal to 1; and
monitoring, by the terminal, a wake-up signal based on the wake-up signal monitoring time information; where
the first information includes at least one of the following parameters:
beacon signal configuration information;
wake-up signal configuration information of the terminal;
time unit configuration information;
wake-up signal monitoring configuration information; and
monitoring relationship configuration information.

According to a second aspect, a wake-up signal monitoring apparatus is provided, including:
a determining module, configured to determine wake-up signal monitoring time information in H beacon signal monitoring periodicities based on first information, where H is an integer greater than or equal to 1; and
a monitoring module, configured to monitor a wake-up signal based on the wake-up signal monitoring time information; where
the first information includes at least one of the following parameters:
beacon signal configuration information;
wake-up signal configuration information of the terminal;
time unit configuration information;
wake-up signal monitoring configuration information; and
monitoring relationship configuration information.

According to a third aspect, a wake-up signal monitoring indication method is provided, including:
sending, by a network-side device, first information to a terminal, where the first information is used for determining, by the terminal, wake-up signal monitoring time information within H beacon signal monitoring periodicities, and H is an integer greater than or equal to 1; and
the first information includes at least one of the following parameters:
beacon signal configuration information;
wake-up signal configuration information of the terminal;
time unit configuration information;
wake-up signal monitoring configuration information; and
monitoring relationship configuration information.

According to a fourth aspect, a wake-up signal monitoring indication apparatus, applied to network-side device and including:
a sending module, configured to send first information to a terminal, where the first information is used for determining, by the terminal, wake-up signal monitoring time information within H beacon signal monitoring periodicities, and H is an integer greater than or equal to 1; and
the first information includes at least one of the following parameters:
beacon signal configuration information;
wake-up signal configuration information of the terminal;
time unit configuration information;
wake-up signal monitoring configuration information; and
monitoring relationship configuration information.

According to a fifth aspect, a terminal is provided, where the terminal includes a processor, a memory, and a program or instructions stored in the memory and capable of running on the processor, and when the program or instructions are executed by the processor, the steps of the method according to the first aspect are implemented.

According to a sixth aspect, a terminal is provided, where the terminal includes a processor and a communication interface, where the processor is configured to determine wake-up signal monitoring time information in H beacon signal monitoring periodicities based on first information, where H is an integer greater than or equal to 1; and
the communication interface is configured to monitor a wake-up signal based on the wake-up signal monitoring time information; where
the first information includes at least one of the following parameters:
beacon signal configuration information;
wake-up signal configuration information of the terminal;
time unit configuration information;
wake-up signal monitoring configuration information; and
monitoring relationship configuration information.

According to a seventh aspect, a network-side device is provided, where the network-side device includes a processor and a memory, where a program or instructions capable of running on the processor are stored in the memory. When the program or the instructions are executed by the processor, the steps of the method according to the third aspect are implemented.

According to an eighth aspect, a network-side device is provided and includes a processor and a communication interface, where the processor is configured to run a program or instructions to implement the steps of the method according to the third aspect, and the communication interface is configured to couple to the processor.

According to a ninth aspect, a communication system is provided, including a terminal and a network-side device, where the terminal can be configured to execute the steps of the wake-up signal monitoring method according to the first aspect; and the network-side device can be configured to execute the steps of the wake-up signal monitoring indication method according to the third aspect.

According to a tenth aspect, a readable storage medium is provided, where a program or instructions are stored in the readable storage medium. When the program or the instructions are executed by a processor, the steps of the method according to the first aspect or the third aspect are implemented.

According to an eleventh aspect, a chip is provided, where the chip includes a processor and a communication interface, the communication interface is coupled to the processor, and the processor is configured to run a program or instructions to implement the method according to the first aspect or the third aspect.

According to a twelfth aspect, a computer program/program product is provided, where the computer program/program product is stored in a storage medium, and the computer program/program product is executed by at least one processor to implement the method according to the first aspect or the third aspect.

### BRIEF DESCRIPTION OF DRAWINGS

FIG. 1 is a block diagram of a wireless communication system to which embodiments of this application are applicable;

FIG. 2 is a schematic diagram of a working principle of NR LP WUR/WUS;

FIG. 3 is a schematic diagram of On-Off-Keying in time domain;

FIG. 4 is a schematic diagram of a frame structure of a beacon signal;

FIG. 5 is a flowchart of a wake-up signal monitoring method according to an embodiment of this application;

FIG. 6 is a schematic diagram of wake-up signal periodicities of different terminals in a case 1;

FIG. 7 is a first schematic diagram of wake-up signal periodicities of different terminals in a case 2;

FIG. 8 is a second schematic diagram of wake-up signal periodicities of different terminals in a case 2;

FIG. 9 is a schematic diagram of a wake-up signal monitoring status of a terminal in a case 3;

FIG. 10 is a schematic diagram of a wake-up signal monitoring status of a terminal in a case 4;

FIG. 11 is a schematic diagram of information interaction between a main communication module and a low-power receiving module inside a terminal;

FIG. 12 is a schematic diagram of modules of a wake-up signal monitoring apparatus according to an embodiment of this application;

FIG. 13 is a schematic structural diagram of a terminal according to an embodiment of this application;

FIG. 14 is a flowchart of a wake-up signal monitoring indication method according to an embodiment of this application;

FIG. 15 is a schematic diagram of modules of a wake-up signal monitoring indication apparatus according to an embodiment of this application;

FIG. 16 is a schematic structural diagram of a network-side device according to an embodiment of this application; and

FIG. 17 is a schematic structural diagram of a communication device according to an embodiment of this application.

### DETAILED DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a long term evolution (Long Term Evolution, LTE) or LTE-Advanced (LTE-Advanced, LTE-A) system, and may also be applied to other wireless communication systems, for example, code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency-division multiple access (Single-carrier Frequency-Division Multiple Access, SC-FDMA), and other systems. The terms “system” and “network” in the embodiments of this application are often used interchangeably, and the technology described herein may be used in the foregoing-mentioned systems and radio technologies as well as other systems and radio technologies. In the following descriptions, a new radio (New Radio, NR) system is described for an illustration purpose, and NR terms are used in most of the following descriptions, although these technologies may also be applied to other applications than an NR system application, for example, the 6^{th} generation (6th Generation, 6G) communication system.

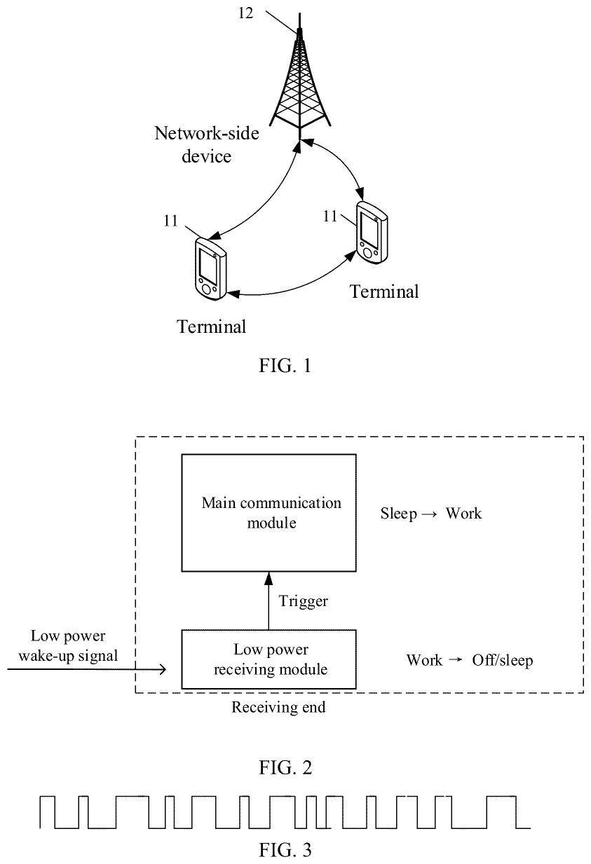

FIG. 1 is a block diagram of a wireless communication system to which the embodiments of this application are applicable. The wireless communication system includes a terminal 11 and a network-side device 12. The terminal 11 may be a mobile phone, a tablet computer (Tablet Personal Computer), a laptop computer (Laptop Computer), a personal digital assistant (personal digital assistant, PDA), a palmtop computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), a smart home device (a home device with wireless communication function, such as a refrigerator, a television, a washing machine, or a furniture), a game console, a personal computer (personal computer, PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a specific type of the terminal 11 is not limited in the embodiments of this application. The network-side device 12 may include an access network device or a core network device, where the access network device may also be referred to as a radio access network device, a radio access network (Radio Access Network, RAN), a radio access network function, or a radio access network unit. The access network device may include a base station, a wireless local area network (Wireless Local Area Network, WLAN) access point, a wireless fidelity Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmission and reception point (Transmitting Receiving Point, TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

The following first describes the related terms involved in the embodiments of this application.

### 1. Low Power Receiver

The low power receiver is a low power wake up radio (low power wake up radio, LP-WUR). The basic working principle of the LP-WUR is that a receiving end includes a first module and a second module. As shown in FIG. 2, specifically, the first module is a main communication module for receiving and sending mobile communication data, and the second module is a low-power receiving module (also referred to as a low-power wake-up receiving module) for receiving the wake-up signal. In an energy-saving state, the terminal turns on the low-power receiving module to monitor an LP-WUS and turns off the main communication module. When downlink data arrives, the network may send a wake-up signal to the terminal, and after detecting the wake-up signal through the low-power receiving module, the terminal may perform a series of judgments and then trigger the main communication module to switch off to on; in this case, the low-power receiving module may enter an off state from a working state. The low-power wake-up receiving module can be turned on continuously or intermittently, and can receive low power wake-up signals when being turned on.

### 2. Low Power Wake-Up Signal (LP-WUS)

A receiver with near “zero” power can be introduced into the receiving module of the terminal to reduce receive activities of the terminal in a standby state, so as to really shut down a radio frequency (Radio Frequency, RF) module and a baseband (Modem) module to greatly reduce power consumption for communication reception. The receiver with near “zero” power only relies on passive matched filtering and signal processing with less power consumption, not requiring complex signal monitoring (such as amplification, filtering, and quantization) of the RF module and signal processing of the modem.

On the base station side, the wake-up signal is triggered on demand (on-demand). On the terminal side, the LP-WUS is received through the WUR, so that the receiver with near “zero” power can be activated to obtain an activation notification, so as to trigger a series of procedures inside the terminal, for example, turning on RF transceiver and baseband processing modules.

Such wake-up signals are usually some simple on-off keying signals (on-off keying), and a time domain pattern of the on-off keying signal is shown in FIG. 3. In this way, the receiver can obtain a wake-up notice through processes of simple energy detection and possible sequence detection and identification. In addition, when the terminal turns on the low-power wake-up receiver to receive the wake-up signal, the main receiver module can work at a lower power consumption level, thus reducing power consumption through reception of wake-up signals.

### 3. Beacon (Beacon) Signal

The beacon signal is a type of signal sent periodically to convey time information. The receiving end can obtain time synchronization information by receiving a beacon signal. In some embodiments, mobility measurement, channel measurement, or the like can alternatively be performed by receiving a beacon signal.

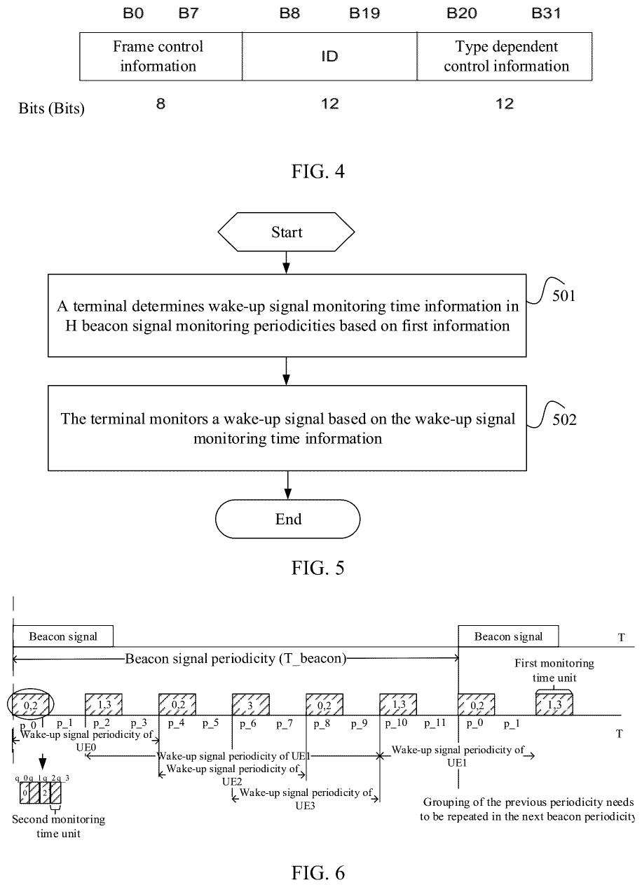

In a related protocol, the beacon signal is transmitted by using a specific medium access control (Medium Access Control, MAC) frame (frame), and its structure is shown in FIG. 4. A WUR beacon is received through the WUR, and a type dependent control (Type dependent control) of a WUR beacon MAC frame carries information of the 5th to 16th bits in a 64-bit time synchronization function (Time Synchronization Function, TSF) clock of the AP. After receiving corresponding information bits, a user updates a local TSF clock of the user according to a time update criteria defined by 802.11ba, so as to achieve the purpose of synchronization with the AP. A WUR beacon sending periodicity and an offset of a sending starting position are indicated by an operation element (operation element) sent by the AP, with the periodicity being the least number of TSF time units between two beacon transmissions, and the starting position being the number of TSF time units deviated from TSF0. When carrier sense multiple access (Carrier Sense Multiple Access, CSMA) deferrals (deferrals) occur, the WUR beacon may be delayed for sending in a current periodicity, but will still be sent at a position that is determined based on a WUR beacon transmission periodicity and a sending starting position in subsequent periodicities.

The following specifically describes a wake-up signal monitoring method and apparatus, a wake-up signal monitoring indication method and apparatus, a terminal, and a network-side device provided in the embodiments of this application through specific embodiments and application scenarios thereof with reference to the accompanying drawings.

As shown in FIG. 5, an embodiment of this application provides a wake-up signal monitoring method, including the following steps.

Step 501: A terminal determines wake-up signal monitoring time information in H beacon signal monitoring periodicities based on first information, where H is an integer greater than or equal to 1.

Step 502: The terminal monitors a wake-up signal based on the wake-up signal monitoring time information.

It should be noted that the wake-up signal in this embodiment of this application includes a low power wake-up signal.

Optionally, the first information includes at least one of the following parameters:

A11. Beacon signal configuration information.

Optionally, the beacon signal configuration information includes at least one of the following:

A111. Beacon signal monitoring periodicity.

It should be noted that the beacon signal monitoring periodicity can be understood as a beacon signal periodicity. Optionally, the beacon signal periodicity is an integer multiple of a first time unit.

A112. Beacon signal monitoring duration.

It should be noted that the beacon signal monitoring duration is a monitoring duration in each beacon signal monitoring periodicity. Optionally, the beacon signal monitoring duration is an integer multiple of the first time unit.

A113. Sequences of H beacon signals, where the sequences of the H beacon signals correspond to the H beacon signal monitoring periodicities.

It should be noted that within one beacon signal periodicity, the terminal monitors one corresponding beacon signal sequence. The sequences of the H beacon signals correspond to H adjacent beacon signal periodicities sequentially, and repeat in time cyclically. The terminal can determine an associated beacon signal periodicity by performing sequence detection on the beacon signal within one beacon signal periodicity, so as to obtain relative time position information in the H beacon signal monitoring periodicities.

A12. Wake-up signal configuration information of the terminal.

Optionally, the wake-up signal configuration information includes at least one of the following:

A121. Wake-up signal monitoring periodicity. Optionally, the wake-up signal monitoring periodicity is related to at least one of the following: a beacon signal periodicity and a wake-up signal sampling periodicity.

The wake-up signal monitoring periodicity is used to indicate a periodicity of monitoring a wake-up signal.

Optionally, the wake-up signal monitoring periodicity of the terminal satisfies at least one of the following:

A1211. The wake-up signal monitoring periodicity is less than or equal to the H beacon signal monitoring periodicities.

A1212. A length of one or the H beacon signal monitoring periodicities is an integer multiple of a length of the wake-up signal monitoring periodicity.

A1213. A length of the wake-up signal monitoring periodicity is an integer multiple of a length of a first time unit.

A122: Wake-up signal monitoring duration information of the terminal.

It should be noted that if a wake-up signal monitoring periodicity is present, the wake-up signal monitoring duration information is wake-up signal monitoring duration information within one monitoring periodicity; or if a wake-up signal monitoring periodicity is absent, the wake-up signal monitoring duration information is used to indicate a total time required for monitoring the wake-up signal by the terminal.

A123. Wake-up signal monitoring starting offset of the terminal.

Optionally, the wake-up signal monitoring starting offset of the terminal includes one of the following:
A1231. a time interval between a starting position of a beacon signal periodicity and a starting position of the wake-up signal monitoring periodicity of the terminal; and
A1232. a time interval between an end position of a beacon signal monitor duration and a starting position of the wake-up signal monitoring periodicity of the terminal.

A13. Time unit configuration information

Optionally, the time unit configuration information includes at least one of the following:

A131. First time unit information, where the first time unit information includes: a unit length of a first time unit.

It should be noted that the first time unit information is used for planning a wake-up signal receiving time unit. In an embodiment, the first time unit is a system frame, that is, a time unit with a length of 10 ms.

A132. Second time unit information, where the second time unit information includes a unit length of a second time unit, and the length of the first time unit is a multiple of the length of the second time unit.

It should be noted that the length of the first time unit should be greater than the length of the second time unit, that is, the first time unit includes one or more second time units. In an embodiment, the second time unit is a subframe, that is, a time unit with a length of 1 ms.

A133. First monitoring time unit, where the first monitoring time unit is a first time unit for monitoring a wake-up signal.

A134. Second monitoring time unit, where the second monitoring time unit is a second time unit used for wake-up signal monitoring.

A14. Wake-up signal monitoring configuration information.

Optionally, the wake-up signal monitoring configuration information includes at least one of the following:

A141. First monitoring configuration information, where the first monitoring configuration information includes at least one of the following: a first value, the first value being the number of first monitoring time units within a length of the H beacon signal monitoring periodicities; a time offset of the first monitoring time unit; and a density of the first monitoring time unit; and

Further, the density of the first monitoring time unit is equal to any one of the following:
the first value divided by a third value; and
the first value divided by a fourth value; where
the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities.

It should be noted here that a time interval between adjacent first monitoring time units can be obtained through deduction based on the density of the first monitoring time unit.

Further, the time offset of the first monitoring time unit is a time offset from a starting time point of a monitoring periodicity of the 1st beacon signal in the H beacon signal monitoring periodicities. For example, a value range of the time offset of the first monitoring time unit is 0 to 1/d1−1, and d1 represents the density of the first monitoring time unit, that is, the value range of the time offset of the first monitoring time unit is any integer value between 0 and 1/d1−1, including 0 and 1/d1−1.

A142. Second monitoring configuration information, where the second monitoring configuration information includes at least one of the following: a second value, the second value being the number of second monitoring time units within a length of one first monitoring time unit; a time offset of the second monitoring time unit; and a density of the second monitoring time unit.

Further, the density of the second monitoring time unit is equal to the second value divided by a fifth value, where the fifth value is the number of second time units within the length of one first monitoring time unit. It should be noted here that a time interval between adjacent second monitoring time units can be deduced based on the density of the second monitoring time unit.

Further, the time offset of the second monitoring time unit is a time offset from a starting time point of the first monitoring time unit. For example, the time offset of the second monitoring time unit is equal to 0. Optionally, the value range of the time offset of the second monitoring time unit is 0 to 1/d2−1, and d2 is the density of the second monitoring time unit, that is, the value range of the time offset of the second monitoring time unit is any integer value between 0 and 1/d2−1, including 0 and 1/d2−1.

A15. Monitoring relationship configuration information.

Optionally, the monitoring relationship configuration information includes at least one of the following:

A151. Identifier of the terminal.

A152: Wake-up signal monitoring subgroup information.

Optionally, the wake-up signal monitoring subgroup information includes at least one of the following:

A1521. the number of first subgroups of wake-up signal monitoring, where the first subgroup is associated with a first monitoring time unit; and

A1522. the number of second subgroups of wake-up signal monitoring, where the second subgroup is associated with a second monitoring time unit.

A153: Wake-up signal monitoring association relationship configuration information.

Optionally, the wake-up signal monitoring association relationship configuration information includes at least one of the following:

A1531. an association relationship between a first subgroup and a first monitoring time unit;

A1532. an association relationship between the terminal and the first subgroup;

A1533. an association relationship between a second subgroup and a second monitoring time unit;

A1534. an association relationship between the terminal and the second subgroup;

A1535. an association relationship between the terminal and the first monitoring time unit; and

A1536. an association relationship between the terminal and the second monitoring time unit.

A154. Wake-up signal monitoring subgroup identification information of the terminal.

Optionally, the wake-up signal monitoring subgroup identification information of the terminal includes at least one of the following:

A1541. an identifier of a first subgroup to which the terminal belongs; and

A1542. an identifier of a second subgroup to which the terminal belongs.

It should be noted that the wake-up signal monitoring time information includes at least one of the following:

B11. a wake-up signal monitoring periodicity of the terminal;

B12. a wake-up signal monitoring starting offset of the terminal;

B13: a wake-up signal monitoring duration of the terminal;

B14. a first monitoring time unit associated with the terminal; and

B15. a second monitoring time unit associated with the terminal.

Optionally, in a case that the wake-up signal monitoring time information includes the wake-up signal monitoring periodicity of the terminal, the determining, by the terminal, the wake-up signal monitoring time information based on the first information includes:
determining, by the terminal, the wake-up signal monitoring periodicity based on a wake-up signal monitoring periodicity in the wake-up signal configuration information of the terminal.

It should be noted here that if time-division multiplexing (time-division multiplexing, TDM) grouping is considered, time domain division can be performed based on a reference time, so that different terminals monitors wake-up signals in different time domains. For a terminal in a radio resource control (Radio Resource Control, RRC) idle (idle) state/RRC inactive (inactive) state, under the LP-WUS monitoring state, the low-power receiver (that is, the low-power receiving module) is turned on, and the main receiver (that is, the main communication module) enters the off state or an ultra-low-power standby state. Synchronization of some timing information such as downlink slot (slot) or symbol (symbol) is difficult to maintain. In this case, for a terminal in an RRC non-connected state (that is, the RRC idle state or RRC inactive state), the beacon (beacon) may be configured accordingly to maintain basic timing and mobility (mobility) requirements during wake-up signal monitoring. Therefore, TDM grouping is performed using a beacon periodicity as a reference in the implementation of this application. In this case, the network device may directly configure the wake-up signal monitoring periodicity for the terminal.

Optionally, in a case that the wake-up signal monitoring time information includes the wake-up signal monitoring starting offset of the terminal, the determining, by a terminal, wake-up signal monitoring time information in H beacon signal monitoring periodicities based on first information includes:
determining, by the terminal, the wake-up signal monitoring starting offset of the terminal based on a wake-up signal monitoring starting offset of the terminal in the wake-up signal configuration information of the terminal.

Optionally, in a case that the wake-up signal monitoring time information includes the wake-up signal monitoring duration of the terminal, the determining, by a terminal, wake-up signal monitoring time information in H beacon signal monitoring periodicities based on first information includes:
determining, by the terminal, the wake-up signal monitoring time information in the H beacon signal monitoring periodicities based on wake-up signal monitoring duration information of the terminal in the wake-up signal configuration information of the terminal.

Optionally, in this case, the terminal determines the wake-up signal monitoring time information based on an absolute beacon periodicity as a reference. In this case, the wake-up signal monitoring time information of the terminal within the H beacon signal monitoring periodicities may be directly configured for the terminal.

Optionally, in a case that the wake-up signal monitoring time information includes a first monitoring time unit associated with the terminal, the determining, by a terminal, wake-up signal monitoring time information in H beacon signal monitoring periodicities based on first information includes:
determining, by the terminal, the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the first monitoring time unit; where
the association relationship between the terminal and the first monitoring time unit is determined based on the identifier of the terminal and the monitoring relationship configuration information of the terminal; or
the association relationship between the terminal and the first monitoring time unit is determined based on the identifier of the terminal, the monitoring relationship configuration information of the terminal, the wake-up signal monitoring subgroup information, and the wake-up signal monitoring subgroup identification information of the terminal.

In an embodiment, the association relationship between the terminal and the first monitoring time unit may be directly configured for the terminal. In this case, the association relationship between the terminal and the first monitoring time unit needs to be configured in the wake-up signal monitoring association relationship configuration information. The association relationship between the terminal and the first monitoring time unit may alternatively be indirectly obtained by the terminal based on the wake-up signal monitoring subgroup information, the wake-up signal monitoring association relationship configuration information, and the wake-up signal monitoring subgroup identification information of the terminal. In this case, an association relationship between a first subgroup and the first monitoring time unit and an association relationship between the terminal and the first subgroup need to be configured in the wake-up signal monitoring association relationship configuration information. An identifier of the first subgroup to which the terminal belongs needs to be configured in the wake-up signal monitoring subgroup identification information, and the number of groups in the first subgroup for wake-up signal monitoring needs to be configured in the wake-up signal monitoring subgroup information.

Optionally, in a case that the wake-up signal monitoring time information includes a second monitoring time unit associated with the terminal, the determining, by a terminal, wake-up signal monitoring time information in H beacon signal monitoring periodicities based on first information includes:
determining, by the terminal, the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the second monitoring time unit; where
the association relationship between the terminal and the second monitoring time unit is determined based on the identifier of the terminal and the monitoring relationship configuration information of the terminal; or
the association relationship between the terminal and the second monitoring time unit is determined based on the identifier of the terminal, the monitoring relationship configuration information of the terminal, the wake-up signal monitoring subgroup information, and the wake-up signal monitoring subgroup identification information of the terminal.

In an embodiment, the association relationship between the terminal and the second monitoring time unit may be directly configured for the terminal. In this case, the correlation between the terminal and the second monitoring time unit should be configured in the wake-up signal monitoring association relationship configuration information. The association relationship between the terminal and the second monitoring time unit may alternatively be indirectly obtained by the terminal based on the wake-up signal monitoring subgroup information, the wake-up signal monitoring association relationship configuration information, and the wake-up signal monitoring subgroup identification information of the terminal. In this case, the association relationship between the second subgroup and the second monitoring time unit and the association relationship between the terminal and the second subgroup needs to be configured in the wake-up signal monitoring association relationship configuration information. An identifier of the second subgroup to which the terminal belongs needs to be configured in the wake-up signal monitoring subgroup identification information, and the number of groups in the second subgroup for wake-up signal monitoring needs to be configured in the wake-up signal monitoring subgroup information.

It should also be noted that in at least one embodiment of this application, the method further includes:
obtaining, by the terminal, the first information; where
a parameter in the first information is configured by a network-side device and/or specified by a protocol.

Optionally, in a case that the parameter in the first information is configured by the network-side device, the obtaining, by the terminal, the first information includes:
obtaining, by the terminal, part or all of parameters in the first information by receiving system information, a radio resource control (RRC) message, or non-access stratum NAS signaling that is sent by the network-side device.

Optionally, in at least one embodiment of this application, the monitoring, by the terminal, a wake-up signal based on the wake-up signal monitoring time information includes:
performing, by the terminal, a first operation in a case that a beacon signal monitoring duration and a monitoring duration of the wake-up signal overlap in time; where
the first operation includes at least one of the following:
skipping, by the terminal, monitoring of the wake-up signal in an overlapping time; and
monitoring the wake-up signal in a non-overlapping time.

In an embodiment, to avoid time domain overlapping between the beacon signal monitoring duration and the LP-WUS monitoring duration, the terminal does not expect to receive the LP-WUS in overlapping time domain, that is, the network-side device may not send an LP-WUS in the beacon signal monitoring duration, or even if the network-side device sends the LP-WUS in the beacon signal monitoring duration, the terminal does not monitor the LP-WUS.

The following describes the embodiments of this application by using examples in a specific application.

Case 1: As shown in FIG. 6, based on an identifier of the terminal (that is, the wake-up signal monitoring time information of the terminal includes the first monitoring time unit associated with the terminal and the second monitoring time unit associated with the terminal), the terminal determines first monitoring time units and second monitoring time units that are associated with one beacon signal periodicity. The terminal monitors a wake-up signal based on the wake-up signal monitoring time information.

The following parameters in the first information of the terminal are configured by the network and/or specified by the protocol:

S11. Identity identification information of the terminal (UE-ID=0).

S12. Beacon signal configuration information.

Specifically, the configuration information includes:
beacon signal monitoring periodicity (T_{beacon}), being configured to be 12 first time unit=12 system frame=120 ms; and
beacon signal monitoring duration information (indicating the duration in each periodicity), being configured to be 30 ms=3 first time units.

S13. Wake-up signal configuration information of the terminal

The wake-up signal monitoring periodicity (T_{WUS}) of the terminal is configured to be four first time units.

S14. The length of the first time unit is 10 ms, that is, a length of one NR system frame.

S15. The length of the second time unit is 2.5 ms.

S16. Wake-up signal monitoring unit configuration information.

The wake-up signal monitoring unit configuration information includes:

S161. First monitoring configuration information.

Specifically, the first monitoring configuration information includes:
the number (N=6) of first monitoring time units within a length of H≥1 beacon signal monitoring periodicities;
a time offset of the first monitoring time unit (TU1_{offset}=0); and
a density of the first monitoring time unit (d1=1/2).

S162. Second monitoring configuration information.

Specifically, the second monitoring configuration information includes:
the number (M=4) of second monitoring time units within a length of one first monitoring time unit;
a time offset of the second monitoring time unit (TU2_{offset}=0); and
a density of the second monitoring time unit (d2=1).

S17. Wake-up signal monitoring association relationship configuration information.

Including an association relationship between the terminal and the first monitoring time unit and an association relationship between the terminal and the second monitoring time unit, where the association relationships are specifically expressed by formula 1 and formula 2 respectively.

$$Formula 1$$

$$( {p}_{index} + TU {1}_{offset} ) mod {T}_{wus} = ( 1 / d 1 ) ⋆ ( UE - ID mod {T}_{wus} ⋆ d 1 )$$

$${q}_{index} = ( UE - ID mod M ) div d 2 + TU {2}_{offset} \qquad Formula 2$$

It should be noted that the following q_{index} and p_{index} are relative values.

P=12 first time units are included in the length of H≥1 beacon signal monitoring periodicities.

Specifically, an index (p_{index}) of the first time unit ranges from 0 to 11. According to sequence information of beacon signals in the beacon signal configuration information, if there is only one beacon signal sequence, then H=1 here.

The first monitoring time unit includes Q=4 second time units.

Specifically, an index (q_{index}) of the second time unit ranges from 0 to 3.

The parameter values mentioned above are previewed as follows:
TU1_{offset}=0;
TU2_{offset}=0;
p_{index} range={0, 11};
q_{index} range={0, 3};
P=12 first time units;
N=6;
Q=4 second time units;
M=4;
T_{beacon}=12 first time units;
T_{WUS}=4 first time units;
UE-ID=0;
d1=1/2; and
d2=1.

Indexes p_{index}, calculated based on the foregoing parameters, of target first monitoring time units (that is, the first monitoring time units) that user equipment (User Equipment, UE) 0 needs to monitor are p₀, p₄ and p₈.

In each target first monitoring time unit requiring monitoring, an index q_{index} of a target second monitoring time unit (that is, the second monitoring time units) that UE0 needs to monitor is q₀. The terminal performs LP-WUS monitoring in the foregoing time unit.

If grouping is limited to within one beacon periodicity, for grouping, grouping in one beacon signal periodicity needs to be restarted at the boundary of each beacon signal periodicity. Therefore, there is no need to set an additional reference time point in this grouping method. The terminal merely needs to find its own group based on the received beacon signal periodicity. For example, in FIG. 6, due to the boundary of the beacon signal periodicity, an LP-WUS periodicity of UE1 may be different from an LP-WUS periodicity of UE1 configured by the network. The LP-WUS periodicity of the UE0 is just a factor of the beacon periodicity, while UE1, UE2, and UE 3 may not be affected by the beacon signal boundary.

In case 1, TDM grouping for multiple UEs is performed in one beacon periodicity, and each UE determines its associated LP-WUS monitoring time based on the first information (including a mapping relationship between the UE and the first monitoring time unit, the second monitoring time unit, UE-ID, UE WUR periodicity, beacon periodicity, and the like), and then monitors an LP-WUS during this monitoring time, so as to reduce the false wake-up rate and power consumption. It should be noted that in this case, TDM grouping for multiple UEs is performed in one beacon periodicity, and therefore an absolute TDM grouping reference time point does not need to be defined. The terminal merely needs to use a beacon periodicity as a reference.

In case 2, to avoid time domain overlapping between wake-up signal monitoring and beacon signal monitoring, the following two schemes are provided:

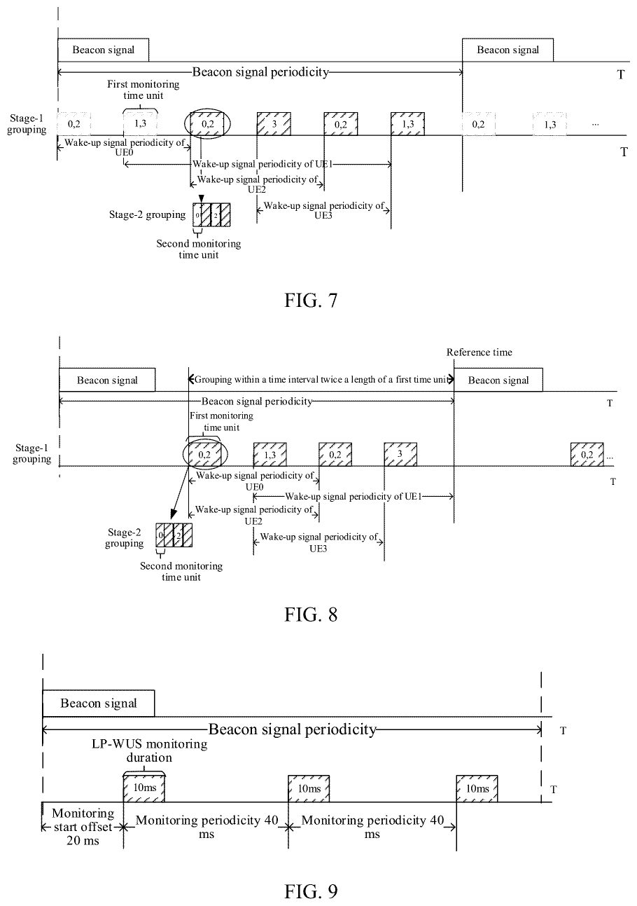

Scheme 1: Being implemented by limiting value ranges of q_{index} and p_{index}. As shown in FIG. 7, the beacon signal monitoring duration is p_{index}=0,1,2. Then limiting the value range of p_{index} to 3 to P-1 can avoid time domain overlapping between wake-up signal monitoring and beacon signal monitoring.

In FIG. 7, two-stage TDM grouping is implemented in one beacon periodicity. Using four UEs 0, 1, 2, and 3 as an example, the network configures their respective wake-up signal monitoring periodicities (WUS periodicity) as shown in FIG. 7. The first monitoring time unit associated with the terminal and the second monitoring time unit associated with the terminal are determined based on the foregoing Formula 1 and Formula 2. In addition, to avoid time domain overlapping between the beacon monitoring duration and the LP-WUS monitoring duration, the terminal does not monitor an LP-WUS in overlapping time domain.

Scheme 2: Being implemented by excluding the beacon monitoring duration in the H beacon periodicities from the first monitoring configuration information and then allocating the first monitoring time unit. Compared with scheme 1, scheme 2 is more complicated to implement. As shown in FIG. 8, to avoid time domain overlapping between the beacon monitoring duration and the LP-WUS monitoring duration, a starting point of the next beacon periodicity is used as a reference point, and a maximum time interval twice the length of the first time unit and not overlapping with the beacon monitoring duration is used for grouping. In FIG. 8, an offset of the first monitoring time interval is 0. Using four UEs 0, 1, 2, and 3 as an example, the network configures their respective wake-up signal monitoring periodicities (WUS periodicity) as shown in FIG. 8. The first monitoring time unit associated with the terminal and the second monitoring time unit associated with the terminal are determined based on the foregoing Formula 1 and Formula 2.

Case 3: As shown in FIG. 9, the wake-up signal monitoring time information is configured for the terminal.

In this case, the following first information, that is, the wake-up signal monitoring time information, is directly configured by the network side for the terminal, mainly including the wake-up signal configuration information of the terminal.

The wake-up signal configuration information includes:

S21. Information of the wake-up signal monitoring periodicity (T_{WUS}) of the terminal, for example, 40 ms.

S22. The wake-up signal monitoring duration information of the terminal is configured to be 10 ms.

S22. Wake-up signal monitoring starting offset of the terminal, for example, 20 ms.

It should be noted that these parameters configured by the network side can be directly used as wake-up signal monitoring time information.

In this case, such wake-up signal monitoring time information in one beacon periodicity may be configured by the network for each terminal based on the foregoing information, and then the terminal can monitor the LP-WUS based on the information. The specific monitoring state is shown in FIG. 9.

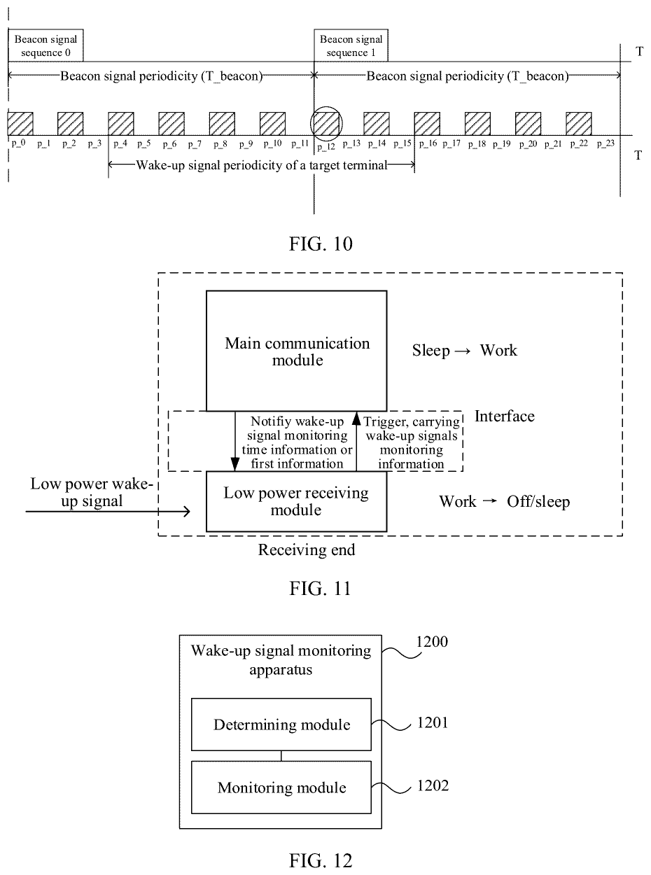

Case 4: As shown in FIG. 10, based on an identifier of the terminal (that is, the wake-up signal monitoring time information of the terminal includes the first monitoring time unit associated with the terminal and the second monitoring time unit associated with the terminal), the terminal determines first monitoring time units and second monitoring time units that are associated with two beacon signal periodicities. The terminal monitors a wake-up signal based on the wake-up signal monitoring time information.

It should be noted that in this case, except for sequence information in the beacon signal configuration information, reference is made to case 1 for other parameters. In this case, H=2, for example, beacon sequences 0 and 1. The network sends beacons 0 and 1 in ascending order of IDs in a corresponding beacon periodicity. As shown in FIG. 10, TDM grouping is implemented in two beacon periodicities. The terminal can determine a current first monitoring time unit ID based on the beacon sequence ID.

The beacon signal configuration information mainly includes: beacon signal sequence information (indicating sequence identifiers or sequence quantity information), where in one beacon signal periodicity, the terminal detects a corresponding beacon signal sequence.

Specifically, in this case, the sequences of the beacon signals are H=2, respectively corresponding to H adjacent beacon signal periodicities in ascending order of sequence IDs. The network side sends beacon signals based on the sequences. The terminal side needs to perform sequence detection to determine which beacon signal periodicity in the H adjacent beacon signal periodicities is a beacon signal sequence currently detected. The specific monitoring state is shown in FIG. 10.

Case 5: Information interaction process between a main communication module and a low-power receiving module in the terminal.

In the foregoing cases 1 to 4, in some application cases, the main communication module of the terminal can transmit part of the first information or the wake-up signal monitoring time information to the low-power receiving module through an internal interface.

For example, the main communication module of the terminal transmits stored first information (for example, grouping information, wake-up signal configuration information, beacon signal configuration information, or timing information) to the low-power receiving module through the interface, so that the low-power receiving module can determine the wake-up signal monitoring time information of the terminal.

For another example, the main communication module of the terminal determines the wake-up signal monitoring time information of the terminal based on the first information, and then sends a determined wake-up signal monitoring time to the low-power receiving module, so that the low-power receiving module merely needs to monitor the wake-up signal based on the monitoring time.

Further, after the low-power receiving module receives the wake-up signal, the main communication module is triggered to switch from a sleep state to a working state. In addition, the low-power receiving module can also transmit related wake-up signal monitoring information (for example, time position information of a monitored wake-up signal relative to the beacon, a type of the monitored wake-up signal, or power size information of the monitored wake-up signal) to the main communication module, for processing by the main communication module accordingly.

Information interaction between the main communication module and the low-power receiving module is shown in FIG. 11.

It should be noted that, in at least one embodiment of this application, to prevent the terminals from being woken up by mistake in the process of LP-WUS monitoring, the terminals are grouped in a TDM manner, and each terminal merely needs to periodically monitor the LP-WUS within a specific duration, with no need to monitor the LP-WUS in entire time domain, so as to avoid the problem of false wake-up caused because the terminal monitors an LP-WUS used for waking up other terminals due to an excessively wide monitoring time, thereby effectively reducing a false wake-up rate (false wake-up rate). In addition, in at least one embodiment of this embodiment of this application, the LP-WUS monitoring time of the terminal is shortened compared with before, thereby reducing power consumption of the terminal in LP-WUS monitoring.

For the wake-up signal monitoring method provided in the embodiments of this application, the execution subject can be a wake-up signal monitoring apparatus. In the embodiments of this application, the wake-up signal monitoring apparatus provided in the embodiments of this application is described by using the wake-up signal monitoring method being executed by the wake-up signal monitoring apparatus as an example.

As shown in FIG. 12, the wake-up signal monitoring apparatus 1200 in this embodiment of this application is applied to a terminal, and includes:
a determining module 1201, configured to determine wake-up signal monitoring time information in H beacon signal monitoring periodicities based on first information, where H is an integer greater than or equal to 1; and
a monitoring module 1202, configured to monitor a wake-up signal based on the wake-up signal monitoring time information; where
the first information includes at least one of the following parameters:
beacon signal configuration information;
wake-up signal configuration information of the terminal;
time unit configuration information;
wake-up signal monitoring configuration information; and
monitoring relationship configuration information.

Optionally, the apparatus further includes:
an obtaining module, configured to obtain first information; where
a parameter in the first information is configured by a network-side device and/or specified by a protocol.

Optionally, in a case that the parameter in the first information is configured by the network-side device, the obtaining module is configured to:
obtain part or all of parameters in the first information by receiving system information, a radio resource control RRC message, or non-access stratum NAS signaling that is sent by the network-side device.

Optionally, the wake-up signal monitoring time information includes at least one of the following:
a wake-up signal monitoring periodicity of the terminal;
a wake-up signal monitoring starting offset of the terminal;
a wake-up signal monitoring duration of the terminal;
a first monitoring time unit associated with the terminal; and
a second monitoring time unit associated with the terminal.

Optionally, in a case that the wake-up signal monitoring time information includes the wake-up signal monitoring periodicity of the terminal, the determining module 1201 is configured to:
determine the wake-up signal monitoring periodicity based on a wake-up signal monitoring periodicity in the wake-up signal configuration information of the terminal.

Optionally, the wake-up signal monitoring periodicity of the terminal satisfies at least one of the following:
the wake-up signal monitoring periodicity is less than or equal to the H beacon signal monitoring periodicities;
a length of one beacon signal monitoring periodicity or the H beacon signal monitoring periodicities is an integer multiple of a length of the wake-up signal monitoring periodicity; and
the length of the wake-up signal monitoring periodicity is an integer multiple of a length of a first time unit.

Optionally, in a case that the wake-up signal monitoring time information includes the wake-up signal monitoring starting offset of the terminal, the determining module 1201 is configured to:

determine the wake-up signal monitoring starting offset of the terminal based on a wake-up signal monitoring starting offset of the terminal in the wake-up signal configuration information of the terminal.

Optionally, the wake-up signal monitoring starting offset of the terminal includes one of the following:
a time interval between a starting position of a beacon signal periodicity and a starting position of the wake-up signal monitoring periodicity of the terminal; and
a time interval between an end position of a beacon signal monitor duration and a starting position of the wake-up signal monitoring periodicity of the terminal.

Optionally, in a case that the wake-up signal monitoring time information includes the wake-up signal monitoring duration of the terminal, the determining module 1201 is configured to:
determine the wake-up signal monitoring time information in the H beacon signal monitoring periodicities based on wake-up signal monitoring duration information of the terminal in the wake-up signal configuration information of the terminal.

Optionally, the monitoring relationship configuration information includes at least one of the following:
an identifier of the terminal;
wake-up signal monitoring subgroup information;
wake-up signal monitoring association relationship configuration information; and
wake-up signal monitoring subgroup identification information of the terminal.

Optionally, the wake-up signal monitoring subgroup information includes at least one of the following:
the number of first subgroups of wake-up signal monitoring, where the first subgroup is associated with a first monitoring time unit; and
the number of second subgroups of wake-up signal monitoring, where the second subgroup is associated with a second monitoring time unit;

Optionally, the wake-up signal monitoring association relationship configuration information includes at least one of the following:
an association relationship between a first subgroup and a first monitoring time unit;
an association relationship between the terminal and the first subgroup;
an association relationship between a second subgroup and a second monitoring time unit;
an association relationship between the terminal and the second subgroup;
an association relationship between the terminal and the first monitoring time unit; and
an association relationship between the terminal and the second monitoring time unit.

Optionally, the wake-up signal monitoring subgroup identification information includes at least one of the following:
an identifier of a first subgroup to which the terminal belongs; and
an identifier of a second subgroup to which the terminal belongs.

Optionally, in a case that the wake-up signal monitoring time information includes a first monitoring time unit associated with the terminal, the determining module 1201 is configured to:
determine the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the first monitoring time unit; where
the association relationship between the terminal and the first monitoring time unit is determined based on the identifier of the terminal and the monitoring relationship configuration information of the terminal; or
the association relationship between the terminal and the first monitoring time unit is determined based on the identifier of the terminal, the monitoring relationship configuration information of the terminal, the wake-up signal monitoring subgroup information, and the wake-up signal monitoring subgroup identification information of the terminal.

Optionally, in a case that the wake-up signal monitoring time information includes a second monitoring time unit associated with the terminal, the determining module 1201 is configured to:
determine the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the second monitoring time unit; where
the association relationship between the terminal and the second monitoring time unit is determined based on the identifier of the terminal and the monitoring relationship configuration information of the terminal; or
the association relationship between the terminal and the second monitoring time unit is determined based on the identifier of the terminal, the monitoring relationship configuration information of the terminal, the wake-up signal monitoring subgroup information, and the wake-up signal monitoring subgroup identification information of the terminal.

Optionally, the time unit configuration information includes at least one of the following:
first time unit information, where the first time unit information includes: a unit length of a first time unit;
second time unit information, where the second time unit information includes a unit length of a second time unit, and the length of the first time unit is a multiple of the length of the second time unit;
a first monitoring time unit, where the first monitoring time unit is a first time unit used for wake-up signal monitoring; and
a second monitoring time unit, where the second monitoring time unit is a second time unit used for wake-up signal monitoring.

Optionally, the wake-up signal monitoring configuration information includes at least one of the following:
first monitoring configuration information, where the first monitoring configuration information includes at least one of the following: a first value, the first value being the number of first monitoring time units within a length of the H beacon signal monitoring periodicities; a time offset of the first monitoring time unit; and a density of the first monitoring time unit; and
second monitoring configuration information, where the second monitoring configuration information includes at least one of the following: a second value, the second value being the number of second monitoring time units within a length of one first monitoring time unit; a time offset of the second monitoring time unit; and a density of the second monitoring time unit.

Optionally, the density of the first monitoring time unit is equal to any one of the following:
the first value divided by a third value; and
the first value divided by a fourth value; where
the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities.

Optionally, the density of the second monitoring time unit is equal to the second value divided by a fifth value, where the fifth value is the number of second time units within the length of one first monitoring time unit.

Optionally, the time offset of the first monitoring time unit is a time offset from a starting time point of a monitoring periodicity of the 1st beacon signal in the H beacon signal monitoring periodicities.

Optionally, the time offset of the second monitoring time unit is a time offset from a starting time point of the first monitoring time unit.

Optionally, the beacon signal configuration information includes at least one of the following:
a beacon signal monitoring periodicity;
a beacon signal monitoring duration; and
sequences of H beacon signals, where the sequences of the H beacon signals correspond to the H beacon signal monitoring periodicities.

Optionally, the monitoring module 1202 is configured to:
perform, for the terminal, a first operation in a case that a beacon signal monitoring duration and a monitoring duration of the wake-up signal overlap in time; where
the first operation includes at least one of the following:
skipping, by the terminal, monitoring of the wake-up signal in an overlapping time; and
monitoring the wake-up signal in a non-overlapping time.

It should be noted that this apparatus embodiment corresponds to the method, and all implementations in the foregoing method embodiments are applicable to this apparatus embodiment, with the same technical effects achieved.

The wake-up signal monitoring apparatus in this embodiment of this application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal 11 listed above, and other devices may be a server, a network attached storage (Network Attached Storage, NAS), and the like. This is not limited in the embodiments of this application.

The wake-up signal monitoring apparatus provided in this embodiment of this application can implement the processes implemented in the method embodiment in FIG. 5, with the same technical effects achieved. To avoid repetition, details are not described herein again.

An embodiment of this application further provides a terminal, where the terminal includes a processor and a communication interface, and the processor is configured to determine wake-up signal monitoring time information in H beacon signal monitoring periodicities based on first information, where H is an integer greater than or equal to 1; and the communication interface is configured to monitor a wake-up signal based on the wake-up signal monitoring time information; where
the first information includes at least one of the following parameters:
beacon signal configuration information;
wake-up signal configuration information of the terminal;
time unit configuration information;
wake-up signal monitoring configuration information; and
monitoring relationship configuration information.

Optionally, the communication interface is further configured to:
obtain first information; where
a parameter in the first information is configured by a network-side device and/or specified by a protocol.

Optionally, in a case that the parameter in the first information is configured by the network-side device, the communication interface is configured to:
obtain part or all of parameters in the first information by receiving system information, a radio resource control RRC message, or non-access stratum NAS signaling that is sent by the network-side device.

Optionally, the wake-up signal monitoring time information includes at least one of the following:
a wake-up signal monitoring periodicity of the terminal;
a wake-up signal monitoring starting offset of the terminal;
a wake-up signal monitoring duration of the terminal;
a first monitoring time unit associated with the terminal; and
a second monitoring time unit associated with the terminal.

Optionally, in a case that the wake-up signal monitoring time information includes the wake-up signal monitoring periodicity of the terminal, the processor is configured to:
determine the wake-up signal monitoring periodicity based on a wake-up signal monitoring periodicity in the wake-up signal configuration information of the terminal.

Optionally, the wake-up signal monitoring periodicity of the terminal satisfies at least one of the following:
the wake-up signal monitoring periodicity is less than or equal to the H beacon signal monitoring periodicities;
a length of one beacon signal monitoring periodicity or the H beacon signal monitoring periodicities is an integer multiple of a length of the wake-up signal monitoring periodicity; and
the length of the wake-up signal monitoring periodicity is an integer multiple of a length of a first time unit.

Optionally, in a case that the wake-up signal monitoring time information includes the wake-up signal monitoring starting offset of the terminal, the processor is configured to:
determine the wake-up signal monitoring starting offset of the terminal based on a wake-up signal monitoring starting offset of the terminal in the wake-up signal configuration information of the terminal.

Optionally, the wake-up signal monitoring starting offset of the terminal includes one of the following:
a time interval between a starting position of a beacon signal periodicity and a starting position of the wake-up signal monitoring periodicity of the terminal; and
a time interval between an end position of a beacon signal monitor duration and a starting position of the wake-up signal monitoring periodicity of the terminal.

Optionally, in a case that the wake-up signal monitoring time information includes the wake-up signal monitoring duration of the terminal, the processor is configured to:
determine the wake-up signal monitoring time information in the H beacon signal monitoring periodicities based on wake-up signal monitoring duration information of the terminal in the wake-up signal configuration information of the terminal.

Optionally, the monitoring relationship configuration information includes at least one of the following:
an identifier of the terminal;
wake-up signal monitoring subgroup information;
wake-up signal monitoring association relationship configuration information; and
wake-up signal monitoring subgroup identification information of the terminal.

Optionally, the wake-up signal monitoring subgroup information includes at least one of the following:
the number of first subgroups of wake-up signal monitoring, where the first subgroup is associated with a first monitoring time unit; and
the number of second subgroups of wake-up signal monitoring, where the second subgroup is associated with a second monitoring time unit;

Optionally, the wake-up signal monitoring association relationship configuration information includes at least one of the following:
an association relationship between a first subgroup and a first monitoring time unit;
an association relationship between the terminal and the first subgroup;
an association relationship between a second subgroup and a second monitoring time unit;
an association relationship between the terminal and the second subgroup;
an association relationship between the terminal and the first monitoring time unit; and
an association relationship between the terminal and the second monitoring time unit.

Optionally, the wake-up signal monitoring subgroup identification information includes at least one of the following:
an identifier of a first subgroup to which the terminal belongs; and
an identifier of a second subgroup to which the terminal belongs.

Optionally, in a case that the wake-up signal monitoring time information includes a first monitoring time unit associated with the terminal, the processor is configured to:
determine the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the first monitoring time unit; where
the association relationship between the terminal and the first monitoring time unit is determined based on the identifier of the terminal and the monitoring relationship configuration information of the terminal; or
the association relationship between the terminal and the first monitoring time unit is determined based on the identifier of the terminal, the monitoring relationship configuration information of the terminal, the wake-up signal monitoring subgroup information, and the wake-up signal monitoring subgroup identification information of the terminal.

Optionally, in a case that the wake-up signal monitoring time information includes a second monitoring time unit associated with the terminal, the processor is configured to:
determine the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the second monitoring time unit; where
the association relationship between the terminal and the second monitoring time unit is determined based on the identifier of the terminal and the monitoring relationship configuration information of the terminal; or
the association relationship between the terminal and the second monitoring time unit is determined based on the identifier of the terminal, the monitoring relationship configuration information of the terminal, the wake-up signal monitoring subgroup information, and the wake-up signal monitoring subgroup identification information of the terminal.

Optionally, the time unit configuration information includes at least one of the following:
first time unit information, where the first time unit information includes: a unit length of a first time unit;
second time unit information, where the second time unit information includes a unit length of a second time unit, and the length of the first time unit is a multiple of the length of the second time unit;
a first monitoring time unit, where the first monitoring time unit is a first time unit used for wake-up signal monitoring; and
a second monitoring time unit, where the second monitoring time unit is a second time unit used for wake-up signal monitoring.

Optionally, the wake-up signal monitoring configuration information includes at least one of the following:
first monitoring configuration information, where the first monitoring configuration information includes at least one of the following: a first value, the first value being the number of first monitoring time units within a length of the H beacon signal monitoring periodicities; a time offset of the first monitoring time unit; and a density of the first monitoring time unit; and
second monitoring configuration information, where the second monitoring configuration information includes at least one of the following: a second value, the second value being the number of second monitoring time units within a length of one first monitoring time unit; a time offset of the second monitoring time unit; and a density of the second monitoring time unit.

Optionally, the density of the first monitoring time unit is equal to any one of the following:
the first value divided by a third value; and
the first value divided by a fourth value; where
the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities.

Optionally, the density of the second monitoring time unit is equal to the second value divided by a fifth value, where the fifth value is the number of second time units within the length of one first monitoring time unit.

Optionally, the time offset of the first monitoring time unit is a time offset from a starting time point of a monitoring periodicity of the 1st beacon signal in the H beacon signal monitoring periodicities.

Optionally, the time offset of the second monitoring time unit is a time offset from a starting time point of the first monitoring time unit.

Optionally, the beacon signal configuration information includes at least one of the following:
a beacon signal monitoring periodicity;
a beacon signal monitoring duration; and
sequences of H beacon signals, where the sequences of the H beacon signals correspond to the H beacon signal monitoring periodicities.

Optionally, the communication interface is configured to:
perform a first operation in a case that a beacon signal monitoring duration and a monitoring duration of the wake-up signal overlap in time; where
the first operation includes at least one of the following:
skipping, by the terminal, monitoring of the wake-up signal in an overlapping time; and
monitoring the wake-up signal in a non-overlapping time.

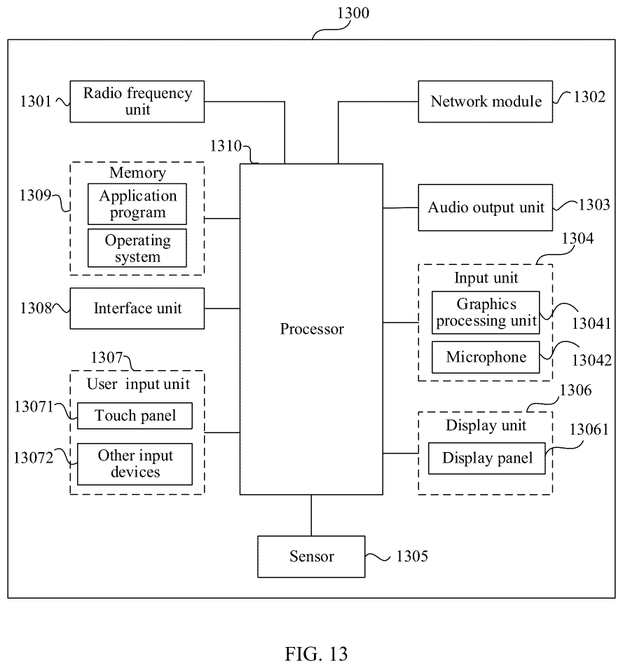

The terminal embodiment corresponds to the foregoing terminal side method embodiment, and the implementation processes and implementations of the foregoing method embodiments can be applied to the terminal embodiments, with the same technical effects achieved. Specifically, FIG. 13 is a schematic diagram of a hardware structure of a terminal implementing an embodiment of this application.

The terminal 1300 includes but is not limited to at least part of components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

Persons skilled in the art can understand that the terminal 1300 may further include a power supply (for example, a battery) supplying power to the components, and the power supply may be logically connected to the processor 1310 through a power management system. In this way, functions such as charge management, discharge management, and power consumption management are implemented by using the power management system. The structure of the terminal shown in FIG. 13 does not constitute any limitation on the terminal. The terminal may include more or fewer components than shown in the figure, or a combination of some components, or the components disposed differently. Details are not described herein again.

It can be understood that in this embodiment of this application, the input unit 1304 may include a graphics processing unit (Graphics Processing Unit, GPU) 13041 and a microphone 13042. The graphics processing unit 13041 processes image data of a still picture or video obtained by an image capture apparatus (such as a camera) in a video capture mode or an image capture mode. The display unit 1306 may include a display panel 13061, and the display panel 13061 may be configured in a form of a liquid crystal display, an organic light-emitting diode, and the like. The user input unit 1307 includes at least one of a touch panel 13071 and other input devices 13072. The touch panel 13071 is also referred to as a touchscreen. The touch panel 13071 may include two parts: a touch detection apparatus and a touch controller. The other input devices 13072 may include but are not limited to a physical keyboard, a function key (such as a volume control key or a power on/off key), a trackball, a mouse, a joystick, and the like. Details are not described herein.

In this embodiment of this application, after receiving downlink data from a network-side device, the radio frequency unit 1301 sends the downlink data to the processor 1310 for processing; and the radio frequency unit 1301 also sends uplink data to the network-side device. Generally, the radio frequency unit 1301 includes, but is not limited to, an antenna, an amplifier, a transceiver, a coupler, a low noise amplifier, a duplexer, and the like.

The memory 1309 may be configured to store software programs or instructions and various data. The memory 1309 may mainly include a first storage area for storing programs or instructions and a second storage area for storing data, where the first storage area may store an operating system, an application program or instructions required by at least one function (for example, an audio playing function and an image playing function), and the like. In addition, the memory 1309 may be a volatile memory or a non-volatile memory, or the memory 1309 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct memory bus random access memory (Direct Rambus RAM, DRRAM). The memory 1309 described in this embodiment of this application includes but is not limited to these and any other suitable types of memories.

The processor 1310 may include one or more processing units. Optionally, the processor 1310 integrates an application processor and a modem processor. The application processor mainly processes operations related to an operating system, a user interface, an application program, and the like. The modem processor mainly processes wireless communication signals, for example, a baseband processor. It should be understood that alternatively, the modem processor may not be integrated into the processor 1310.

The processor 1310 is configured to:
determine wake-up signal monitoring time information in H beacon signal monitoring periodicities based on first information, where H is an integer greater than or equal to 1.

The radio frequency unit 1301 is configured to:
monitor a wake-up signal based on the wake-up signal monitoring time information; where
the first information includes at least one of the following parameters:
beacon signal configuration information;
wake-up signal configuration information of the terminal;
time unit configuration information;
wake-up signal monitoring configuration information; and
monitoring relationship configuration information.

Further, the radio frequency unit 1301 is further configured to:
obtain first information; where
a parameter in the first information is configured by a network-side device and/or specified by a protocol.

Optionally, in a case that the parameter in the first information is configured by the network-side device, the radio frequency unit 1301 is configured to:
obtain part or all of parameters in the first information by receiving system information, a radio resource control RRC message, or non-access stratum NAS signaling that is sent by the network-side device.

Optionally, the wake-up signal monitoring time information includes at least one of the following:
a wake-up signal monitoring periodicity of the terminal;
a wake-up signal monitoring starting offset of the terminal;
a wake-up signal monitoring duration of the terminal;
a first monitoring time unit associated with the terminal; and
a second monitoring time unit associated with the terminal.

Optionally, in a case that the wake-up signal monitoring time information includes the wake-up signal monitoring periodicity of the terminal, the processor 1310 is configured to:
determine the wake-up signal monitoring periodicity based on a wake-up signal monitoring periodicity in the wake-up signal configuration information of the terminal.

Optionally, the wake-up signal monitoring periodicity of the terminal satisfies at least one of the following:
the wake-up signal monitoring periodicity is less than or equal to the H beacon signal monitoring periodicities;
a length of one beacon signal monitoring periodicity or the H beacon signal monitoring periodicities is an integer multiple of a length of the wake-up signal monitoring periodicity; and
the length of the wake-up signal monitoring periodicity is an integer multiple of a length of a first time unit.

Optionally, in a case that the wake-up signal monitoring time information includes the wake-up signal monitoring starting offset of the terminal, the processor 1310 is configured to:
determine the wake-up signal monitoring starting offset of the terminal based on a wake-up signal monitoring starting offset of the terminal in the wake-up signal configuration information of the terminal.

Optionally, the wake-up signal monitoring starting offset of the terminal includes one of the following:
a time interval between a starting position of a beacon signal periodicity and a starting position of the wake-up signal monitoring periodicity of the terminal; and
a time interval between an end position of a beacon signal monitor duration and a starting position of the wake-up signal monitoring periodicity of the terminal.

Optionally, in a case that the wake-up signal monitoring time information includes the wake-up signal monitoring duration of the terminal, the processor 1310 is configured to:
determine the wake-up signal monitoring time information in the H beacon signal monitoring periodicities based on wake-up signal monitoring duration information of the terminal in the wake-up signal configuration information of the terminal.

Optionally, the monitoring relationship configuration information includes at least one of the following:
an identifier of the terminal;
wake-up signal monitoring subgroup information;
wake-up signal monitoring association relationship configuration information; and
wake-up signal monitoring subgroup identification information of the terminal.

Optionally, the wake-up signal monitoring subgroup information includes at least one of the following:
the number of first subgroups of wake-up signal monitoring, where the first subgroup is associated with a first monitoring time unit; and
the number of second subgroups of wake-up signal monitoring, where the second subgroup is associated with a second monitoring time unit;
Optionally, the wake-up signal monitoring association relationship configuration information includes at least one of the following:
an association relationship between a first subgroup and a first monitoring time unit;
an association relationship between the terminal and the first subgroup;
an association relationship between a second subgroup and a second monitoring time unit;
an association relationship between the terminal and the second subgroup;
an association relationship between the terminal and the first monitoring time unit; and
an association relationship between the terminal and the second monitoring time unit.

Optionally, the wake-up signal monitoring subgroup identification includes at least one of the following:
an identifier of a first subgroup to which the terminal belongs; and
an identifier of a second subgroup to which the terminal belongs.

Optionally, in a case that the wake-up signal monitoring time information includes a first monitoring time unit associated with the terminal, the processor 1310 is configured to:
determine the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the first monitoring time unit; where
the association relationship between the terminal and the first monitoring time unit is determined based on the identifier of the terminal and the monitoring relationship configuration information of the terminal; or
the association relationship between the terminal and the first monitoring time unit is determined based on the identifier of the terminal, the monitoring relationship configuration information of the terminal, the wake-up signal monitoring subgroup information, and the wake-up signal monitoring subgroup identification information of the terminal.

Optionally, in a case that the wake-up signal monitoring time information includes a second monitoring time unit associated with the terminal, the processor 1310 is configured to:
determine the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the second monitoring time unit; where
the association relationship between the terminal and the second monitoring time unit is determined based on the identifier of the terminal and the monitoring relationship configuration information of the terminal; or
the association relationship between the terminal and the second monitoring time unit is determined based on the identifier of the terminal, the monitoring relationship configuration information of the terminal, the wake-up signal monitoring subgroup information, and the wake-up signal monitoring subgroup identification information of the terminal.

Optionally, the time unit configuration information includes at least one of the following:
first time unit information, where the first time unit information includes: a unit length of a first time unit;
second time unit information, where the second time unit information includes a unit length of a second time unit, and the length of the first time unit is a multiple of the length of the second time unit;
a first monitoring time unit, where the first monitoring time unit is a first time unit used for wake-up signal monitoring; and
a second monitoring time unit, where the second monitoring time unit is a second time unit used for wake-up signal monitoring.

Optionally, the wake-up signal monitoring configuration information includes at least one of the following:
first monitoring configuration information, where the first monitoring configuration information includes at least one of the following: a first value, the first value being the number of first monitoring time units within a length of the H beacon signal monitoring periodicities; a time offset of the first monitoring time unit; and a density of the first monitoring time unit; and
second monitoring configuration information, where the second monitoring configuration information includes at least one of the following: a second value, the second value being the number of second monitoring time units within a length of one first monitoring time unit; a time offset of the second monitoring time unit; and a density of the second monitoring time unit.

Optionally, the density of the first monitoring time unit is equal to any one of the following:
the first value divided by a third value; and
the first value divided by a fourth value; where
the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities.

Optionally, the density of the second monitoring time unit is equal to the second value divided by a fifth value, where the fifth value is the number of second time units within the length of one first monitoring time unit.

Optionally, the time offset of the first monitoring time unit is a time offset from a starting time point of a monitoring periodicity of the 1st beacon signal in the H beacon signal monitoring periodicities.

Optionally, the time offset of the second monitoring time unit is a time offset from a starting time point of the first monitoring time unit.

Optionally, the beacon signal configuration information includes at least one of the following:
a beacon signal monitoring periodicity;
a beacon signal monitoring duration; and
sequences of H beacon signals, where the sequences of the H beacon signals correspond to the H beacon signal monitoring periodicities.

Optionally, the radio frequency unit 1301 is configured to:
perform a first operation in a case that a beacon signal monitoring duration and a monitoring duration of the wake-up signal overlap in time; where
the first operation includes at least one of the following:
skipping, by the terminal, monitoring of the wake-up signal in an overlapping time; and
monitoring the wake-up signal in a non-overlapping time.

Preferably, an embodiment of this application further provides a terminal, including a processor and a memory, where a program or instructions capable of running on the processor are stored in the memory, and when the program or instructions are executed by the processor, the processes of the foregoing embodiments of the wake-up signal monitoring method are implemented, with the same technical effects achieved. To avoid repetition, details are not described herein again.

An embodiment of this application further provides a readable storage medium, where the computer readable storage medium has stored thereon a program or instructions, and when the program or the instructions are executed by a processor, the processes of the foregoing embodiments of the wake-up signal monitoring method are implemented, with the same technical effects achieved. To avoid repetition, details are not described herein again.

For example, the computer-readable storage medium is a read-only memory (Read-Only Memory, ROM for short), a random access memory (Random Access Memory, RAM for short), a magnetic disk, an optical disc, or the like.

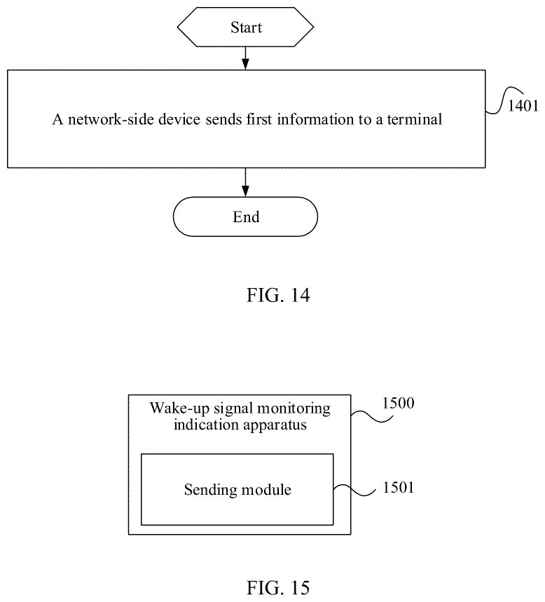

As shown in FIG. 14, an embodiment of this application provides a wake-up signal monitoring indication method, including the following steps.

Step 1401: A network-side device sends first information to a terminal, where the first information is used for determining, by the terminal, wake-up signal monitoring time information within H beacon signal monitoring periodicities, and H is an integer greater than or equal to 1; where
the first information includes at least one of the following parameters:
beacon signal configuration information;
wake-up signal configuration information of the terminal;
time unit configuration information;
wake-up signal monitoring configuration information; and
monitoring relationship configuration information.

Optionally, that the network-side device sends the first information to the terminal includes:
sending, by the network-side device, the first information to the terminal through system information, a radio resource control RRC message, or non-access stratum NAS signaling.

Optionally, the monitoring relationship configuration information includes at least one of the following:
an identifier of the terminal;
wake-up signal monitoring subgroup information;
wake-up signal monitoring association relationship configuration information; and
wake-up signal monitoring subgroup identification information of the terminal.

Optionally, the wake-up signal monitoring subgroup information includes at least one of the following:
the number of first subgroups of wake-up signal monitoring, where the first subgroup is associated with a first monitoring time unit; and
the number of second subgroups of wake-up signal monitoring, where the second subgroup is associated with a second monitoring time unit;
Optionally, the wake-up signal monitoring association relationship configuration information includes at least one of the following:
an association relationship between a first subgroup and a first monitoring time unit;
an association relationship between the terminal and the first subgroup;
an association relationship between a second subgroup and a second monitoring time unit;
an association relationship between the terminal and the second subgroup;
an association relationship between the terminal and the first monitoring time unit; and
an association relationship between the terminal and the second monitoring time unit.

Optionally, the wake-up signal monitoring subgroup identification information includes at least one of the following:
an identifier of a first subgroup to which the terminal belongs; and
an identifier of a second subgroup to which the terminal belongs.

Optionally, the time unit configuration information includes at least one of the following:
first time unit information, where the first time unit information includes: a unit length of a first time unit;
second time unit information, where the second time unit information includes a unit length of a second time unit, and the length of the first time unit is a multiple of the length of the second time unit;
a first monitoring time unit, where the first monitoring time unit is a first time unit used for wake-up signal monitoring; and
a second monitoring time unit, where the second monitoring time unit is a second time unit used for wake-up signal monitoring.

Optionally, the wake-up signal monitoring configuration information includes at least one of the following:
first monitoring configuration information, where the first monitoring configuration information includes at least one of the following: a first value, the first value being the number of first monitoring time units within a length of the H beacon signal monitoring periodicities; a time offset of the first monitoring time unit; and a density of the first monitoring time unit; and
second monitoring configuration information, where the second monitoring configuration information includes at least one of the following: a second value, the second value being the number of second monitoring time units within a length of one first monitoring time unit; a time offset of the second monitoring time unit; and a density of the second monitoring time unit.

Optionally, the density of the first monitoring time unit is equal to any one of the following:
the first value divided by a third value; and
the first value divided by a fourth value; where
the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities.

Optionally, the density of the second monitoring time unit is equal to the second value divided by a fifth value, where the fifth value is the number of second time units within the length of one first monitoring time unit.

Optionally, the time offset of the first monitoring time unit is a time offset from a starting time point of a monitoring periodicity of the 1st beacon signal in the H beacon signal monitoring periodicities.

Optionally, the time offset of the second monitoring time unit is a time offset from a starting time point of the first monitoring time unit.

Optionally, the beacon signal configuration information includes at least one of the following:
a beacon signal monitoring periodicity;
a beacon signal monitoring duration; and
sequences of H beacon signals, where the sequences of the H beacon signals correspond to the H beacon signal monitoring periodicities.

It should be noted that all the descriptions about the network-side device in the foregoing embodiments are applicable to the embodiments of the wake-up signal monitoring indication method applied to the network-side device, with the same technical effects achieved. Details are not repeated here.

As shown in FIG. 15, the wake-up signal monitoring indication apparatus 1500 of this embodiment of this application is applied to a network-side device, and includes:

a sending module 1501, configured to send first information to a terminal, where the first information is used for determining, by the terminal, wake-up signal monitoring time information within H beacon signal monitoring periodicities, and H is an integer greater than or equal to 1; and
the first information includes at least one of the following parameters:
beacon signal configuration information;
wake-up signal configuration information of the terminal;
time unit configuration information;
wake-up signal monitoring configuration information; and
monitoring relationship configuration information.

Optionally, the sending module 1501 is configured to:
send the first information to the terminal through system information, a radio resource control RRC message, or non-access stratum NAS signaling.

Optionally, the monitoring relationship configuration information includes at least one of the following:
an identifier of the terminal;
wake-up signal monitoring subgroup information;
wake-up signal monitoring association relationship configuration information; and
wake-up signal monitoring subgroup identification information of the terminal.

Optionally, the wake-up signal monitoring subgroup information includes at least one of the following:
the number of first subgroups of wake-up signal monitoring, where the first subgroup is associated with a first monitoring time unit; and
the number of second subgroups of wake-up signal monitoring, where the second subgroup is associated with a second monitoring time unit;

Optionally, the wake-up signal monitoring association relationship configuration information includes at least one of the following:
an association relationship between a first subgroup and a first monitoring time unit;
an association relationship between the terminal and the first subgroup;
an association relationship between a second subgroup and a second monitoring time unit;
an association relationship between the terminal and the second subgroup;
an association relationship between the terminal and the first monitoring time unit; and
an association relationship between the terminal and the second monitoring time unit.

Optionally, the wake-up signal monitoring subgroup identification information includes at least one of the following:
an identifier of a first subgroup to which the terminal belongs; and
an identifier of a second subgroup to which the terminal belongs.

Optionally, the time unit configuration information includes at least one of the following:
first time unit information, where the first time unit information includes: a unit length of a first time unit;
second time unit information, where the second time unit information includes a unit length of a second time unit, and the length of the first time unit is a multiple of the length of the second time unit;
a first monitoring time unit, where the first monitoring time unit is a first time unit used for wake-up signal monitoring; and
a second monitoring time unit, where the second monitoring time unit is a second time unit used for wake-up signal monitoring.

Optionally, the wake-up signal monitoring configuration information includes at least one of the following:
first monitoring configuration information, where the first monitoring configuration information includes at least one of the following: a first value, the first value being the number of first monitoring time units within a length of the H beacon signal monitoring periodicities; a time offset of the first monitoring time unit; and a density of the first monitoring time unit; and
second monitoring configuration information, where the second monitoring configuration information includes at least one of the following: a second value, the second value being the number of second monitoring time units within a length of one first monitoring time unit; a time offset of the second monitoring time unit; and a density of the second monitoring time unit.

Optionally, the density of the first monitoring time unit is equal to any one of the following:
the first value divided by a third value; and
the first value divided by a fourth value; where
the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities.

Optionally, the density of the second monitoring time unit is equal to the second value divided by a fifth value, where the fifth value is the number of second time units within the length of one first monitoring time unit.

Optionally, the time offset of the first monitoring time unit is a time offset from a starting time point of a monitoring periodicity of the 1st beacon signal in the H beacon signal monitoring periodicities.

Optionally, the time offset of the second monitoring time unit is a time offset from a starting time point of the first monitoring time unit.

Optionally, the beacon signal configuration information includes at least one of the following:
a beacon signal monitoring periodicity;
a beacon signal monitoring duration; and
sequences of H beacon signals, where the sequences of the H beacon signals correspond to the H beacon signal monitoring periodicities.

It should be noted that this apparatus embodiment corresponds to the apparatus, and all implementations in the foregoing method embodiments are applicable to this apparatus embodiment, with the same technical effects achieved. Details are not repeated here.

An embodiment of this application further provides a network-side device, including a processor and a communication interface, where the communication interface is configured to send first information to a terminal, where the first information is used for determining, by the terminal, wake-up signal monitoring time information within H beacon signal monitoring periodicities, and H is an integer greater than or equal to 1; where
the first information includes at least one of the following parameters:
beacon signal configuration information;
wake-up signal configuration information of the terminal;
time unit configuration information;
wake-up signal monitoring configuration information; and
monitoring relationship configuration information.

Optionally, the communication interface is configured to:
send the first information to the terminal through system information, a radio resource control RRC message, or non-access stratum NAS signaling.

Optionally, the monitoring relationship configuration information includes at least one of the following:
an identifier of the terminal;
wake-up signal monitoring subgroup information;
wake-up signal monitoring association relationship configuration information; and
wake-up signal monitoring subgroup identification information of the terminal.

Optionally, the wake-up signal monitoring subgroup information includes at least one of the following:
the number of first subgroups of wake-up signal monitoring, where the first subgroup is associated with a first monitoring time unit; and
the number of second subgroups of wake-up signal monitoring, where the second subgroup is associated with a second monitoring time unit;

Optionally, the wake-up signal monitoring association relationship configuration information includes at least one of the following:
an association relationship between a first subgroup and a first monitoring time unit;
an association relationship between the terminal and the first subgroup;
an association relationship between a second subgroup and a second monitoring time unit;
an association relationship between the terminal and the second subgroup;
an association relationship between the terminal and the first monitoring time unit; and
an association relationship between the terminal and the second monitoring time unit.

Optionally, the wake-up signal monitoring subgroup identification information includes at least one of the following:
an identifier of a first subgroup to which the terminal belongs; and
an identifier of a second subgroup to which the terminal belongs.

Optionally, the time unit configuration information includes at least one of the following:
first time unit information, where the first time unit information includes: a unit length of a first time unit;
second time unit information, where the second time unit information includes a unit length of a second time unit, and the length of the first time unit is a multiple of the length of the second time unit;
a first monitoring time unit, where the first monitoring time unit is a first time unit used for wake-up signal monitoring; and
a second monitoring time unit, where the second monitoring time unit is a second time unit used for wake-up signal monitoring.

Optionally, the wake-up signal monitoring configuration information includes at least one of the following:
first monitoring configuration information, where the first monitoring configuration information includes at least one of the following: a first value, the first value being the number of first monitoring time units within a length of the H beacon signal monitoring periodicities; a time offset of the first monitoring time unit; and a density of the first monitoring time unit; and
second monitoring configuration information, where the second monitoring configuration information includes at least one of the following: a second value, the second value being the number of second monitoring time units within a length of one first monitoring time unit; a time offset of the second monitoring time unit; and a density of the second monitoring time unit.

Optionally, the density of the first monitoring time unit is equal to any one of the following:
the first value divided by a third value; and
the first value divided by a fourth value; where
the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities.

Optionally, the density of the second monitoring time unit is equal to the second value divided by a fifth value, where the fifth value is the number of second time units within the length of one first monitoring time unit.

Optionally, the time offset of the first monitoring time unit is a time offset from a starting time point of a monitoring periodicity of the 1st beacon signal in the H beacon signal monitoring periodicities.

Optionally, the time offset of the second monitoring time unit is a time offset from a starting time point of the first monitoring time unit.

Optionally, the beacon signal configuration information includes at least one of the following:
a beacon signal monitoring periodicity;
a beacon signal monitoring duration; and
sequences of H beacon signals, where the sequences of the H beacon signals correspond to the H beacon signal monitoring periodicities.

Preferably, an embodiment of this application further provides a network-side device, including a processor and a memory, where a program or instructions capable of running on the processor are stored in the memory, and when the program or instructions are executed by the processor, the processes of the foregoing embodiments of the wake-up signal monitoring indication method are implemented, with the same technical effects achieved. To avoid repetition, details are not described herein again.

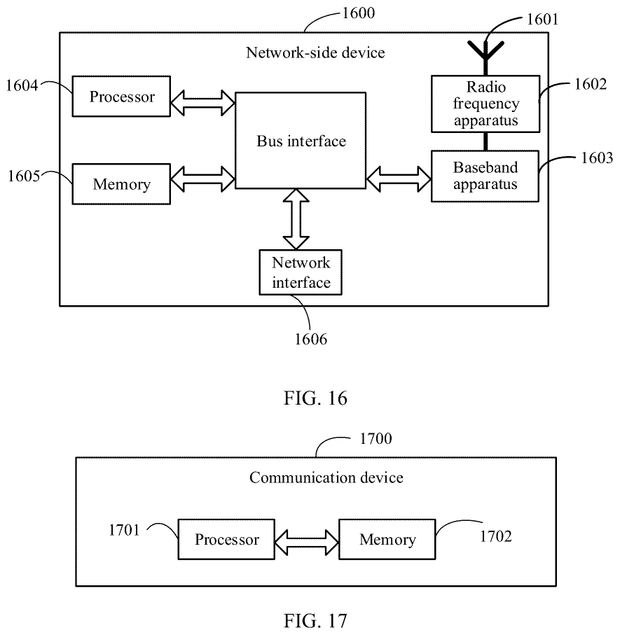

Specifically, an embodiment of this application further provides a network-side device. As shown in FIG. 16, the network-side device 1600 includes an antenna 1601, a radio frequency apparatus 1602, a baseband apparatus 1603, a processor 1604, and a memory 1605. The antenna 1601 is connected to the radio frequency apparatus 1602. In an uplink direction, the radio frequency apparatus 1602 receives information by using the antenna 1601, and sends the received information to the baseband apparatus 1603 for processing. In a downlink direction, the baseband apparatus 1603 processes to-be-sent information, and sends the information to the radio frequency apparatus 1602; and the radio frequency apparatus 1602 processes the received information and then sends the information out by using the antenna 1601.

The method performed by the network-side device in the foregoing embodiment may be implemented in the baseband apparatus 1603, and the baseband apparatus 1603 includes a baseband processor.

The baseband apparatus 1603 may include, for example, at least one baseband processing unit, where a plurality of chips are disposed on the baseband processing unit. As shown in FIG. 16, one of the chips is, for example, the baseband processor, and connected to the memory 1605 through a bus interface, to invoke the program in the memory 1605 to perform the operations of the network device shown in the foregoing method embodiment.

The network-side device may further include a network interface 1606, where the interface is, for example, a common public radio interface (common public radio interface, CPRI).

Specifically, the network-side device 1600 according to this embodiment of this application further includes instructions or programs stored in the memory 1605 and capable of running on the processor 1604, and the processor 1604 calls the instructions or programs in the memory 1605 to execute the methods performed by the modules shown in FIG. 15, with the same technical effects achieved. To avoid repetition, details are not described herein again.

An embodiment of this application further provides a readable storage medium, where the readable storage medium has stored thereon a program or instructions, and when the program or the instructions are executed by a processor, the processes of the foregoing embodiments of the wake-up signal monitoring indication method are implemented, with the same technical effects achieved. To avoid repetition, details are not described herein again.

The processor is the processor in the access network device in the foregoing embodiment. The readable storage medium includes a computer readable storage medium, such as a computer read-only memory ROM, a random access memory RAM, a magnetic disk, or an optical disc.

Optionally, as shown in FIG. 17, an embodiment of this application further provides a communication device 1700, including a processor 1701 and a memory 1702. A program or instructions capable of running on the processor 1701 are stored in the memory 1702. For example, when the communication device 1700 is a terminal and when the program or the instructions are executed by the processor 1701, the steps of the foregoing embodiments of the wake-up signal monitoring method are implemented, with the same technical effects achieved When the communication device 1700 is a network-side device and when the program or the instructions are executed by the processor 1701, the steps of the foregoing embodiments of the wake-up signal monitoring indication method are implemented, with the same technical effects achieved. To avoid repetition, details are not described herein again.

An embodiment of this application further provides a chip. The chip includes a processor and a communication interface. The communication interface is coupled to the processor. The processor is configured to run a program or instructions to implement the processes of the foregoing embodiments of the wake-up signal monitoring method or the wake-up signal monitoring indication method, with the same technical effect achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and when being executed by at least one processor, the computer program/program product is configured to implement the processes of the foregoing embodiments of the wake-up signal monitoring method, with the same technical effects achieved. To avoid repetition, details are not repeated herein.

An embodiment of this application further provides a communication system, including a terminal and a network-side device, where the terminal can be configured to execute the steps of the wake-up signal monitoring method described above, and the network-side device can be configured to execute the steps of the wake-up signal monitoring indication method described above.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. Certainly, the method in the foregoing embodiment may also be implemented by hardware. However, in many cases, the former is a preferred implementation. Based on such an understanding, the technical solutions of the present invention essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this disclosure.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A wake-up signal monitoring method, comprising:
determining, by a terminal, wake-up signal monitoring time information in H beacon signal monitoring periodicities based on first information, wherein H is an integer greater than or equal to 1; and
monitoring, by the terminal, a wake-up signal based on the wake-up signal monitoring time information; wherein
the first information comprises at least one of the following parameters:
beacon signal configuration information;
wake-up signal configuration information of the terminal;
time unit configuration information;
wake-up signal monitoring configuration information; and
monitoring relationship configuration information.

2. The method according to claim 1, further comprising:
obtaining, by the terminal, the first information; wherein
a parameter in the first information is configured by a network-side device and/or specified by a protocol.

3. The method according to claim 2, wherein in a case that the parameter in the first information is configured by the network-side device, the obtaining, by the terminal, the first information comprises:
obtaining, by the terminal, part or all of parameters in the first information by receiving system information, a radio resource control (RRC) message, or non-access stratum (NAS) signaling that is sent by the network-side device.

4. The method according to claim 1, wherein the wake-up signal monitoring time information comprises at least one of the following:
a wake-up signal monitoring periodicity of the terminal;
a wake-up signal monitoring starting offset of the terminal;
a wake-up signal monitoring duration of the terminal;
a first monitoring time unit associated with the terminal; and
a second monitoring time unit associated with the terminal.

5. The method according to claim 4, wherein in a case that the wake-up signal monitoring time information comprises the wake-up signal monitoring periodicity of the terminal, the determining, by the terminal, the wake-up signal monitoring time information based on the first information comprises:
determining, by the terminal, the wake-up signal monitoring periodicity based on a wake-up signal monitoring periodicity in the wake-up signal configuration information of the terminal.

6. The method according to claim 4, wherein the wake-up signal monitoring periodicity of the terminal satisfies at least one of the following:
the wake-up signal monitoring periodicity is less than or equal to the H beacon signal monitoring periodicities;
a length of one beacon signal monitoring periodicity or the H beacon signal monitoring periodicities is an integer multiple of a length of the wake-up signal monitoring periodicity; and
the length of the wake-up signal monitoring periodicity is an integer multiple of a length of a first time unit.

7. The method according to claim 4, wherein the determining, by a terminal, wake-up signal monitoring time information in H beacon signal monitoring periodicities based on first information comprises at least one of:
in a case that the wake-up signal monitoring time information comprises the wake-up signal monitoring starting offset of the terminal, determining, by the terminal, the wake-up signal monitoring starting offset of the terminal based on a wake-up signal monitoring starting offset of the terminal in the wake-up signal configuration information of the terminal; and
in a case that the wake-up signal monitoring time information comprises the wake-up signal monitoring duration of the terminal, determining, by the terminal, the wake-up signal monitoring time information in the H beacon signal monitoring periodicities based on wake-up signal monitoring duration information of the terminal in the wake-up signal configuration information of the terminal.

8. The method according to claim 4, wherein the wake-up signal monitoring starting offset of the terminal comprises one of the following:
a time interval between a starting position of a beacon signal periodicity and a starting position of the wake-up signal monitoring periodicity of the terminal; and
a time interval between an ending position of a beacon signal monitor duration and a starting position of the wake-up signal monitoring periodicity of the terminal.

9. The method according to claim 1, wherein the monitoring relationship configuration information comprises at least one of the following:
an identifier of the terminal;
wake-up signal monitoring subgroup information, comprising at least one of: the number of first subgroups of wake-up signal monitoring, wherein the first subgroup is associated with a first monitoring time unit; and the number of second subgroups of wake-up signal monitoring, wherein the second subgroup is associated with a second monitoring time unit;
wake-up signal monitoring association relationship configuration information, comprising at least one of: an association relationship between a first subgroup and a first monitoring time unit; an association relationship between the terminal and the first subgroup; an association relationship between a second subgroup and a second monitoring time unit; an association relationship between the terminal and the second subgroup; an association relationship between the terminal and the first monitoring time unit; and an association relationship between the terminal and the second monitoring time unit; and
wake-up signal monitoring subgroup identification information of the terminal, comprising at least one of an identifier of a first subgroup to which the terminal belongs; and an identifier of a second subgroup to which the terminal belongs.

10. The method according to claim 9, wherein in a case that the wake-up signal monitoring time information comprises a first monitoring time unit associated with the terminal, the determining, by a terminal, wake-up signal monitoring time information in H beacon signal monitoring periodicities based on first information comprises:
determining, by the terminal, the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the first monitoring time unit; wherein
the association relationship between the terminal and the first monitoring time unit is determined based on the identifier of the terminal and the monitoring relationship configuration information of the terminal; or
the association relationship between the terminal and the first monitoring time unit is determined based on the identifier of the terminal, the monitoring relationship configuration information of the terminal, the wake-up signal monitoring subgroup information, and the wake-up signal monitoring subgroup identification information of the terminal.

11. The method according to claim 9, wherein in a case that the wake-up signal monitoring time information comprises a second monitoring time unit associated with the terminal, the determining, by a terminal, wake-up signal monitoring time information in H beacon signal monitoring periodicities based on first information comprises:
determining, by the terminal, the wake-up signal monitoring time information in the H beacon signal monitoring periodicities based on the beacon signal configuration information, the wake-up signal configuration information of the terminal, the time unit configuration information, the wake-up signal monitoring configuration information, and an association relationship between the terminal and the second monitoring time unit; wherein
the association relationship between the terminal and the second monitoring time unit is determined based on the identifier of the terminal and the monitoring relationship configuration information of the terminal; or
the association relationship between the terminal and the second monitoring time unit is determined based on the identifier of the terminal, the monitoring relationship configuration information of the terminal, the wake-up signal monitoring subgroup information, and the wake-up signal monitoring subgroup identification information of the terminal.

12. The method according to claim 1, wherein the time unit configuration information comprises at least one of the following:
first time unit information, wherein the first time unit information comprises: a unit length of a first time unit;
second time unit information, wherein the second time unit information comprises a unit length of a second time unit, and the length of the first time unit is a multiple of the length of the second time unit;
a first monitoring time unit, wherein the first monitoring time unit is a first time unit used for wake-up signal monitoring; and
a second monitoring time unit, wherein the second monitoring time unit is a second time unit used for wake-up signal monitoring.

13. The method according to claim 1, wherein the wake-up signal monitoring configuration information comprises at least one of the following:
first monitoring configuration information, wherein the first monitoring configuration information comprises at least one of the following: a first value, the first value being the number of first monitoring time units within a length of the H beacon signal monitoring periodicities; a time offset of the first monitoring time unit; and a density of the first monitoring time unit; and
second monitoring configuration information, wherein the second monitoring configuration information comprises at least one of the following: a second value, wherein the second value being the number of second monitoring time units within a length of one first monitoring time unit; a time offset of the second monitoring time unit; and a density of the second monitoring time unit.

14. The method according to claim 13, wherein:
the density of the first monitoring time unit is equal to the first value divided by a third value or a fourth value; and
the density of the second monitoring time unit is equal to the second value divided by a fifth value,
wherein the third value is the number of first time units within the length of the H beacon signal monitoring periodicities, the fourth value is the number of first time units within a remaining time length, and the remaining time length is equal to the length of the H beacon signal monitoring periodicities minus a monitoring duration in the H beacon signal monitoring periodicities, and the fifth value is the number of second time units within the length of one first monitoring time unit.

15. The method according to claim 13, wherein:
the time offset of the first monitoring time unit is a time offset from a starting time point of a monitoring periodicity of the 1st beacon signal in the H beacon signal monitoring periodicities; and
the time offset of the second monitoring time unit is a time offset from a starting time point of the first monitoring time unit.

16. The method according to claim 1, wherein the beacon signal configuration information comprises at least one of the following:
a beacon signal monitoring periodicity;
a beacon signal monitoring duration; and
sequences of H beacon signals, wherein the sequences of the H beacon signals correspond to the H beacon signal monitoring periodicities.

17. The method according to claim 1, wherein the monitoring, by the terminal, a wake-up signal based on the wake-up signal monitoring time information comprises:
performing, by the terminal, a first operation in a case that a beacon signal monitoring duration and a monitoring duration of the wake-up signal overlap in time; wherein
the first operation comprises at least one of the following:
skipping, by the terminal, monitoring of the wake-up signal in an overlapping time; and
monitoring the wake-up signal in a non-overlapping time.

18. A wake-up signal monitoring indication method, comprising:
sending, by a network-side device, first information to a terminal, wherein the first information is used for determining, by the terminal, wake-up signal monitoring time information within H beacon signal monitoring periodicities, and His an integer greater than or equal to 1; and
the first information comprises at least one of the following parameters:
beacon signal configuration information;
wake-up signal configuration information of the terminal;
time unit configuration information;
wake-up signal monitoring configuration information; and
monitoring relationship configuration information.

19. A terminal, comprising a processor and a memory, wherein the memory has stored thereon a program or instructions capable of running on the processor, and when the program or instructions are executed by the processor, the expectation causes the terminal to perform:
determining wake-up signal monitoring time information in H beacon signal monitoring periodicities based on first information, wherein His an integer greater than or equal to 1; and
monitoring a wake-up signal based on the wake-up signal monitoring time information; wherein the first information comprises at least one of the following parameters:
beacon signal configuration information;
wake-up signal configuration information of the terminal;
time unit configuration information;
wake-up signal monitoring configuration information; and
monitoring relationship configuration information.

20. A network-side device, comprising a processor and a memory, wherein the memory has stored thereon a program or instructions capable of running on the processor, and when the program or instructions are executed by the processor, the steps of the wake-up signal monitoring indication method according to claim 18 are implemented.
